(19) United States
(12) Patent Application Publication
(10) Pub. No.: US 2018/0375328 A1
(43) Pub. Date: Dec. 27, 2018

(54) METHOD FOR MANAGING A GROUP OF ELECTRICAL ENERGY CONSUMING DEVICES, AND ELECTRICAL ENERGY MANAGEMENT MODULE

(71) Applicants: ELECTRICITE DE FRANCE, Paris (FR); INSTITUT MINES TELECOM, Paris (FR)

(72) Inventors: Melaine Rousselle, Vanves (FR); Philippe Forestier, Chatillon (FR); Sawsan Al Zahr, Paris (FR)

(21) Appl. No.: 15/781,613

(22) PCT Filed: Dec. 6, 2016
(86) PCT No.: PCT/FR2016/053230

§ 371 Date: Jun. 5, 2018

(30) Foreign Application Priority Data
Dec. 8, 2015 (FR) 15 62001

(51) Int. Cl. H02J 3/14; G06Q 50/06; B60L 11/18

(52) U.S. Cl. CPC H02J 3/14; G06Q 50/06; H02J 2003/007; B60L 11/184; H02J 2003/143; B60L 11/1848

(57) ABSTRACT

A method for managing a group of electrical energy consuming devices allows reducing the electrical consumption cost for some devices when the supply of electricity to said devices can be deferred. The method is particularly suitable for flexible power supply devices, and, in particular, when at least one of the devices is an electric vehicle that is connected in order to charge batteries of said vehicle.

### TECHNICAL FIELD OF INVENTION

The present invention relates to a method for managing a group of electrical energy consuming devices. It also relates to an electrical energy management module.

### PRIOR ART

There are already many methods for managing the supply of electrical energy to one or more devices connected to one and same electrical energy delivery point. For example, this may concern all electrical devices of a residence, including a domestic hot water production system, a washing machine, a kitchen oven, etc. The supply of electrical energy to these devices is generally subject to two constraints. First, the instantaneous electric power which is provided in order to supply with energy certain devices simultaneously must not exceed a maximum electrical power value that is fixed for the delivery point. This maximum electrical power value depends on the design of the electrical facility downstream and upstream of the delivery point. In particular, the delivery point installation cost varies with this maximum electrical power value. Moreover, for the occupant of the residence, the price of the service contract with the electricity provider is higher when the electric power that is contracted is higher. Finally, for contracted electric power and maximum available electric power rating values which are determined, the cost of the electrical consumption is desired to be as low as possible. However, some of the devices have operations that may be mandatory or take priority over other devices. For example, hot water production by hot water tanks is commonly deferred to time slots where the cost of electrical consumption is lower. Thus, during time slots where the consumption cost is higher, the supply of electrical energy can be devoted to priority devices without exceeding the contracted power rating value.

In the context of the present description, and according to common usage, the term “power rating” for an electrical device is understood to mean the amount of energy per unit of time, expressed for example in kilowatts (kW), which is required for the device to operate. “Electrical consumption,” expressed for example in kilowatt-hours (kWh), is understood to mean the amount of electrical energy supplied to one or more device(s) to enable it (them) to operate. Finally, the expression “operation of a device” may indicate not only the activation of the device in order to perform in real time the function and/or effects for which it was designed, but possibly also an operation of recharging electrical energy storage batteries with which the device may be provided, to enable it to perform at a later time the function and/or effects for which it was designed.

Electric vehicles are a new type of electrical device that can be connected to an electrical energy delivery point which is dedicated to a residence, building, or site of business activities such as an industrial site for example. However, charging the electric batteries of such a vehicle can consume significant power, with a high power rating value. This power rating value, significant in comparison to the value of the electric power that is available from the delivery point, can interfere with the electrical supply to other devices if the sum of the power rating values of the devices to be simultaneously supplied exceeds the value of the maximum electric power that is available at the delivery point. However, it is often possible to delay charging the batteries of an electric vehicle to time slots where the total demand for electric power is reduced and/or the cost of electrical consumption is lower.

In the near future, some devices such as electric vehicles or domestic hot water production systems may have multiple electrical energy supply modes corresponding to different power ratings. Such devices are said to be flexible power supply devices. Most often, the electrical consumption of the device is substantially identical for all supply modes, and variations in the supply duration can compensate for reductions in power.

Based on this situation, an object of the invention consists in more efficiently managing multiple devices that are supplied with electrical energy from a single electrical energy delivery point, in order to reduce the cost of the electrical consumption of these devices.

A secondary object of the invention is to further improve the management of the electrical energy supplied to multiple devices when at least one of them is a flexible power supply device.

Another object is to reduce the capacity that is needed, and therefore the cost, of the installation of the electrical energy delivery point, for a same group of devices to be supplied with electrical energy.

Yet another object of the invention is to reduce the contracted power rating value, meaning the cost of the service contract with the electricity provider, for a same group of devices to be electrically supplied.

Finally, a general object of the invention is also to contribute to reducing peak loads in the power grid.

### SUMMARY OF THE INVENTION

To achieve at least one of these or other objects, a first aspect of the invention provides a method for managing a group of devices which consume electrical energy, in order to supply these devices with electrical energy from an electrical energy delivery point that is common to the devices. The method of the invention comprises the following steps:
/1/ collecting values of an electric power which is available at the delivery point as a function of successive time slots, and collecting electrical consumption pricing data for each of the time slots;
/2/ for each device: collecting characteristics of a supply mode of this device, comprising an electrical consumption value, a power rating value and a supply duration, the power rating value being defined for each moment of the supply duration; and further collecting two limit times between which its supply duration is scheduled;
/3/ ranking the devices of the group in descending order of their electrical consumption values;
/4/ for the first device in the ranking established in step /3/, performing the following substeps:
   /4-1/ determining a starting time for electrically supplying the first device, which satisfies the following conditions:
      allows supplying the first device in accordance with the characteristics of its supply mode and within the limit times collected for this first device;
      the power rating of the first device is less than or equal to the value of the electric power that is available from the delivery point for the entire supply duration of the first device from the starting time; and
      the starting time minimizes a cost of supplying electricity to the first device, calculated by applying the pricing data; and
   /4-2/ updating the values of the electric power that is available from the delivery point, by subtracting the value of the power rating of the first device for each time slot during the supply duration of the first device from the starting time, and without modifying the values of the electric power that is available from the delivery point outside of the supply duration of the first device; then
/5/ repeating step /4/ for each device of the group, in the order of the ranking established in step /3/, and with the updated values of the electric power that is available from the delivery point.

Such a method allows giving priority to supplying the devices that have the highest electrical consumptions, in order to ensure that the operation of these devices is fully accommodated with minimal delay.

In addition, such a method ensures that the total power which is required at each moment is less than or equal to the value of the electric power that is available from the delivery point.

The method also minimizes the cost of the electrical energy consumed by the devices.

It also allows reducing the capacity of the electrical facility upstream and downstream of the delivery point, since it reduces the instantaneous electric power demanded from the delivery point.

For the same reason, the method of the invention allows reducing the power contracted for and therefore the cost of the service contract with the electricity provider, for the user or the occupant of the residence, for a same group of electrical devices.

Finally, such a method is easy to program and implement in an electrical energy management module, to be inserted between the delivery point and the electrical connections that link the devices.

The method of the invention is particularly suitable, in particular, when one of the devices of the group of devices comprises an electric vehicle connected to the delivery point in order to charge batteries of the vehicle, and/or comprises a domestic hot water production system. Indeed, the operations of these two types of devices can be deferred to an extent consistent with the requirements of their use.

A first improvement of the invention allows taking into account devices for which the supply of electrical energy has priority, for example when these devices have a safety function or are used on demand to perform a function immediately. In this case, in step /1/ of the method of the invention, the values of the electric power that is available at the delivery point can be calculated for each time slot based on a fixed maximum electric power value for the delivery point, from which is subtracted a power rating value concerning at least one other device that consumes electrical energy, which is in addition to the group of devices, and for which the supply of electrical energy from the delivery point has priority. Optionally, each device having priority may be indicated to a power manager implementing the management method. Alternatively, a device having priority may be identified by the power manager via machine-learning based on priority information which has been entered at multiple occasions by a user during a first time period.

A second improvement of the invention takes advantage of the possible ability of at least one of the devices of the group of devices, to be supplied alternatively according to several different modes. Such a device, said to be a flexible power supply device, has multiple supply modes associated with respective power rating values which are different. Steps /3/ and /4/ are then executed for this flexible power supply device by adopting the supply mode that has the highest power rating value, referred to as the first supply mode, in order to determine the starting time for supplying electricity. However, if time slots exist subsequent to the starting time and during the supply duration of the first supply mode, for which the power rating value of that first supply mode is greater than the value of the electric power that is available at the delivery point, then another supply mode for the flexible power supply device is adopted for these subsequent time slots with excess power demand. This other supply mode is the one which has, among the supply modes of the flexible power supply device, the largest of the power rating values that are less than or equal to the available electric power value, among all supply modes of the flexible power supply device. In addition, a deficit in the electrical consumption is calculated for the flexible power supply device, resulting from the adoption of a supply mode other than the first. A dummy device is then added to the group of devices processed according to the management method, this dummy device having a plurality of supply modes with the same power rating values as the flexible power supply device, but using the electrical consumption deficit calculated for the flexible power supply device as the electrical consumption value for the supply modes of the dummy device, and for determining the respective supply durations of the supply modes of the dummy device.

Such a flexible power supply device may comprise an electric vehicle that is connected to the delivery point in order to charge batteries of the vehicle, or a domestic hot water production system.

In addition, the characteristics of each supply mode of at least one of the devices may be sent to a power manager implementing the management method, by an operator of the device or by the device itself. Alternatively, these characteristics may be determined by the power manager via machine-learning based on power characteristics recorded during a second period of time.

In general, the electrical energy delivery point may be assigned to a residence, in particular an apartment or a detached house, at least part of a building, in particular a multi-dwelling residential building or a commercial building, or at least part of a site, in particular an industrial site.

Also in general, the management method of the invention may be used for forecasting electrical consumption or for estimating the costs of such consumption. Alternatively, the devices in the group of devices may be supplied with electrical energy from the delivery point in accordance with starting times determined during executions of substep /4-1/ and in accordance with the supply modes of the devices used to determine these starting times, or adopted for each time slot. When supplying electricity to the devices, at least some characteristics of the supply mode among the electrical consumption value, the power rating value, and the supply duration, can be updated for at least one of devices while this device is being supplied with electrical energy in accordance with the management method. This update may be carried out based on at least one power measurement which is performed in real time for the device.

Again in general, step /4/ of the management method may further comprise the following substep:
/4-3/ updating a value for a total cost of electrical consumption, by adding the cost of the electrical consumption of the device for which the starting time for supplying electricity was determined in the last execution of substep /4-1/, to a previous value of the total cost of electrical consumption determined based on the devices for which the starting times for supplying electricity were determined in previous executions of substep /4-1/.

A second aspect of the invention provides an electrical energy management module which is adapted to implement a management method according to the first aspect of the invention, and which comprises:
a first input adapted to receive values of a maximum electric power which is available at the electrical energy delivery point shared between multiple devices which consume electrical energy;
a second input adapted to receive electrical consumption pricing data for successive electrical consumption time slots;
third inputs adapted to receive characteristics of respective supply modes of the devices; and
power outputs adapted to be each connected to at least one of the devices, in order to supply these devices with electrical energy;

Such a module may be adapted for installation at the electrical energy delivery point of a residence, of at least part of a building or site.

Optionally, the management module may further comprise a fourth input which is adapted to receive at least one information item designating one of the devices as having priority for the supply of electrical energy. Optionally, the module may additionally or alternatively comprise first storage means adapted to store supply priority information which has been entered at multiple occasions by a user during a first period of time. It may then also comprise first learning means adapted to automatically identify at least one of the devices as having supply priority. Such learning may be based on the supply priority information entered. When taking into consideration devices possibly having priority, the module may be further adapted to subtract the power rating value of each priority device which is designated by such an information item or which is identified by learning, from the value of the maximum electric power that is available at the delivery point. The residual electric power value is then available to supply the at least one of the devices not designated as having priority for the supply of electrical energy.

Also optionally, the management module may further comprise second measurement and storage means which are adapted for measuring and storing the power characteristics of the device during a second period of time. It may then also comprise second learning means adapted for automatically determining the characteristics of each supply mode of the at least one of the devices, based on the power characteristics recorded.

### BRIEF DESCRIPTION OF FIGURES

Other features and advantages of the invention will be apparent from the following description of some non-limiting examples of its implementation, with reference to the accompanying drawings in which:

FIG. 1 illustrates an application of the invention to a residence;

FIG. 2 is a diagram of steps of a method according to the invention; and

FIG. 3 is a detailed diagram of one of the steps of the method of FIG. 2.

### DETAILED DESCRIPTION OF THE INVENTION

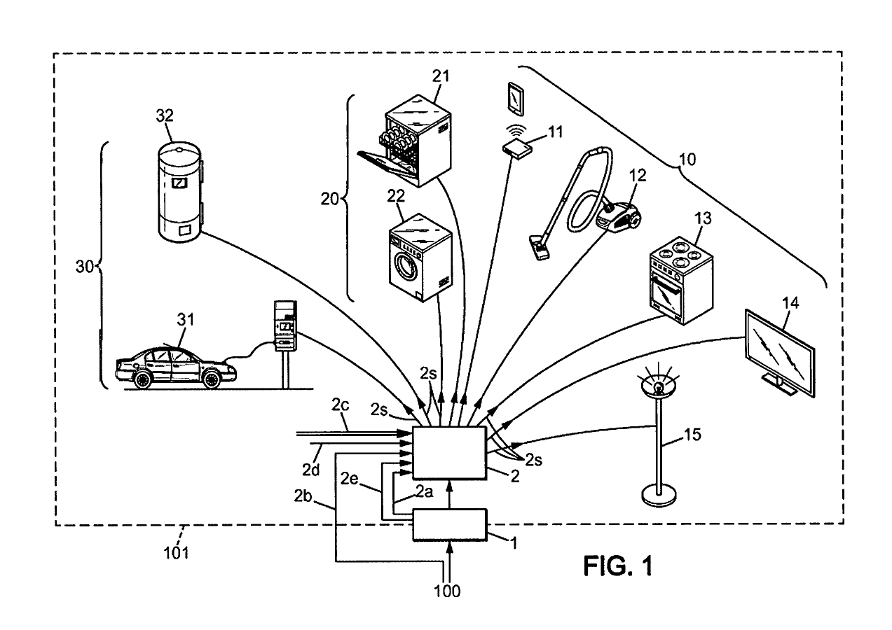

An application of the invention to a residence 101 is now described with reference to FIG. 1. The reference 100 denotes an electricity provider for the residence 101, and the reference 1 designates an electrical energy delivery point for the residence 101, assumed to be single delivery point for simplicity. The delivery point 1 usually corresponds to an electricity meter capable of measuring the instantaneous electric power supplied to the residence 101, and of producing a total of the electrical consumption that occurred in the residence 101 during a given period.

Usually, an electric power value is assigned to the delivery point 1, for example under a commercial contract that signed with the electricity provider by an occupant of the residence 101. This electric power value is usually called the contracted power rating value. It is less than another value, called the connection value, which corresponds to the capacity of the electrical facility serving the residence 101. Thus, the value of the maximum electric power available at a given time for the residence 101 is less than the connection value. It may depend on operating constraints of the power grid, such as maintaining a nominal voltage for the user.

Also usually, the electricity provider 100 establishes a fee structure for electrical consumption, with consumption pricing which may vary between predetermined time slots. The cost of the electrical consumption for the occupant of the residence 101 can then be calculated as the sum, for all successive time slots, of the electrical consumption during each time slot multiplied by a price per kilowatt-hour for that time slot. Most often, the price per kilowatt-hour to be used may also depend on the maximum electric power value assigned to the delivery point 1.

The residence 101 contains multiple devices to be supplied electrical energy from the delivery point 1, including for example: a box for connecting to the Internet 11, a vacuum cleaner 12, a kitchen appliance 13, a television 14, a lighting system 15, a dishwasher 21, a washing machine 22, a battery charger connected to an electric vehicle 31, a domestic hot water production system 32, etc., these being non-limiting and provided as examples only.

To implement the invention, an electrical energy management module 2 can be inserted between the delivery point 1 and the power lines that connect the electrical energy consuming devices of the residence 101. Each power line is then connected to a power output 2s of the module 2. The function of the module 2 is to manage the supply of electrical energy to at least some of the devices of the residence 101 over time, in order to reduce the cost of electrical consumption while remaining within the maximum electric power value of the delivery point 1.

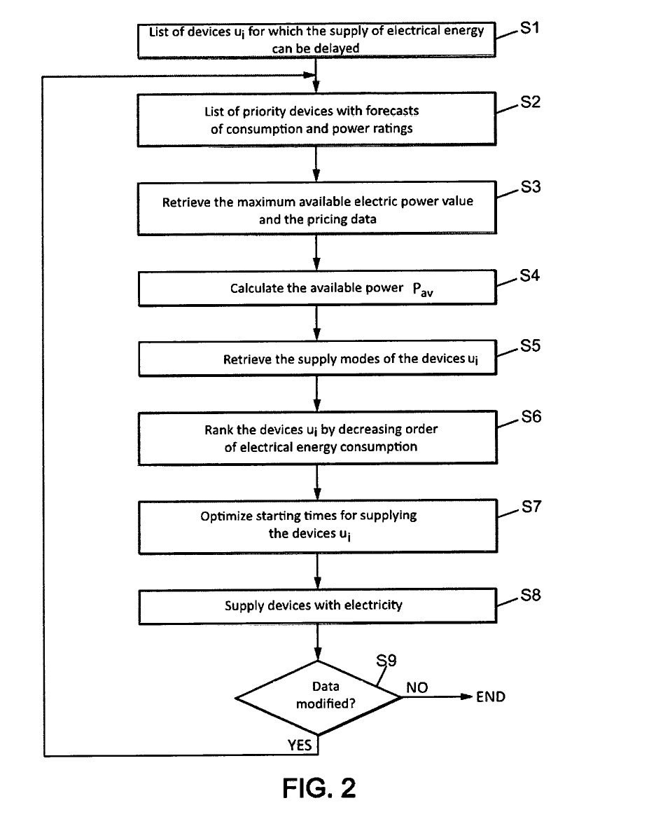

To this end, it must be possible to defer or postpone the supply of electrical energy to at least some of the devices that are supplied from the delivery point 1. These devices for which the supply of electrical energy can be deferred are identified in a list that is communicated to the module 2 in step S1 (FIG. 2). They are denoted uᵢ, where i is an integer index that identifies each device, varying from 1 to N where N is the number of devices for which the supply of electricity can be deferred.

Additionally, a list may also be established in step S2 for devices of the residence 101 for which the supply of electricity cannot be deferred. The supply of electrical energy to these devices is given priority over those listed in step S1. The electrical consumption of each of these devices having priority for the supply of electrical energy may be predictable or random, and in particular may be dependent on a start command which is actuated by the occupant of the residence 101, or may be imposed by a safety requirement etc. In particular, among the devices shown in FIG. 1, the box for connecting to the Internet 11, the vacuum cleaner 12, the kitchen appliance 13, the television 14, and the lighting system 15 have priority when scheduled or turned on by the occupant of the residence 101. They are grouped together in the group 10 which is the subject of the list declared in step S2. Other devices, grouped in groups 20 and 30, are the devices uᵢ for which the supply of electricity can be deferred.

Each uᵢ or priority device is declared to the module 2 in the form of a vector that defines its supply mode, and which comprises at least some of the following characteristics:
a value of the electric power rating of the device, which is denoted Pᵢ for device uᵢ at each moment of its operation;
a minimum limit time for starting the supply of electricity, which is denoted for device uᵢ;
the maximum limit time for ending the supply of electricity, which is denoted τᵢ′ for device uᵢ;
a power supply duration, for example to produce the function of this device or to ensure complete charging of its batteries, denoted tcᵢ for device uᵢ; and
an electrical consumption value which corresponds to the power supply duration and power rating values of the device, and which is denoted Eᵢ for device uᵢ.

The electrical power rating value Pᵢ of device uᵢ, or of a priority device, may vary during its supply duration. This variation may be known. In this case, it is stored in the vector of the supply mode of the device in the form of a series of electrical power rating values which are each associated with a period within the power supply duration. In the following, the electrical power rating value Pᵢ which is used to predict or carry out the supply of electricity to the priority device or device uᵢ is selected based on the period concerned during the power supply duration of the device.

The value of the maximum electric power which is available from the delivery point 1 is retrieved in step S3 (FIG. 2) by the module 2. This value may be sent from the electricity meter which is located at the delivery point 1, by a dedicated input 2a of the module 2, called the first input in the general part of this description. Depending on the applications of the invention, it is not required that this maximum available electric power value be constant over time. It is possible for it to vary according to successive time slots, for example with a daily or weekly frequency.

Pricing data, for example a list of kilowatt-hour rates for the electrical consumption time slots, are also sent to the module 2 in step S3, for example by the electricity provider 100 via input 2b, called the second input of the module 2 in the general part of this description.

The characteristics of the supply modes of the devices are sent to the module 2 by inputs 2c, called the third inputs of the module 2 in the general part of this description. These characteristics mainly concern the devices uᵢ able to have a deferred start. These characteristics may be entered initially in the module 2, or may be sent to the module 2 by the devices during an automatic initialization sequence. Alternatively, these characteristics of the supply modes of the devices may be measured and the measurement results sent to the module 2 by one or more dedicated inputs (see input 2e presented below). In another alternative, these characteristics of the supply modes of the devices may be determined by the module 2 itself by implementing a machine-learning sequence, for example based on power measurements that are recorded over a period of time. The skilled person knows many learning algorithms that can be used here.

A fourth input 2d of the module 2 may be dedicated to indicating to the module 2 the devices that have priority for the supply of electricity, meaning those of group 10. Alternatively, the devices having priority for the supply of electricity may be identified by the module 2 by implementing another machine-learning sequence, for example based on priority information which has been entered at multiple occasions by the user during a predetermined period of time.

Finally, the module 2 may further have a fifth entry 2e dedicated to sending the results of measurements performed in real time during the supply of electricity to at least some of the devices. These measurements may concern the power supplied to some of the devices, their supply durations or their electrical consumptions, or the total electric power supplied to the residence 101 by the delivery point 1. The results of these measurements can be used to update some of the data used later in the method of the invention. The measurement means required may be integrated into the electricity meter which is located at the delivery point 1, or integrated into the module 2 itself.

Step S4 consists in determining the electric power which is available to each device uᵢ able to have a deferred start. This value is denoted Pₐᵥ for each time slot, for example over a rolling period of 24 hours, it being understood that the value of Pₐᵥ can vary between successive time slots. For each time slot, it can be obtained by subtracting from the value of the maximum electric power that is available from the delivery point 1, the sum of the power rating values for all devices which have priority for the supply of electricity during this time slot, meaning the devices of group 10.

The characteristics of the supply modes of the devices uᵢ are retrieved in step S5 by the module 2, for example at inputs 2c or 2e.

The devices uᵢ whose supply of electricity can be deferred are ranked in step S6 in descending order of their respective electrical consumptions Eᵢ.

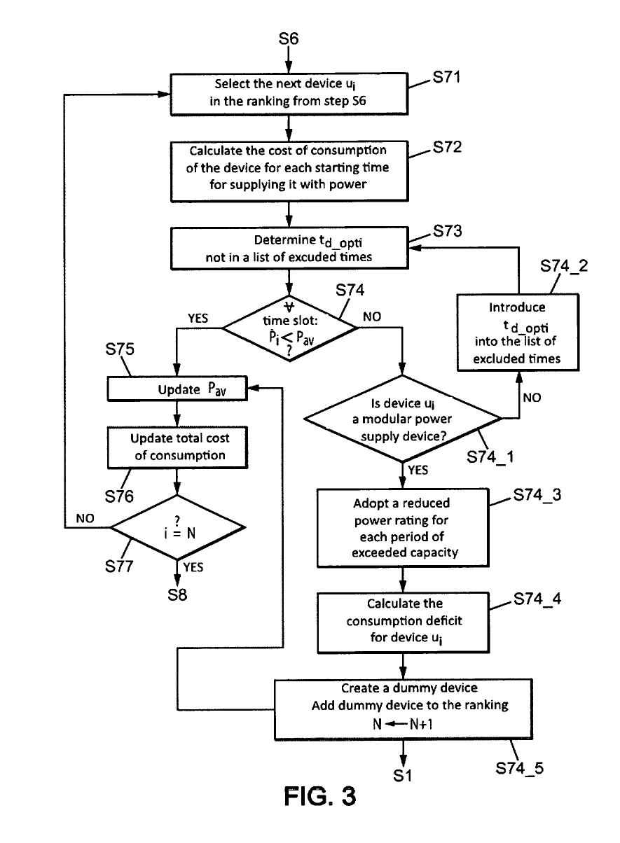

Step S7, of which one particular implementation is detailed in FIG. 3, is dedicated specifically to managing the supply of electrical energy to the devices uᵢ once the devices having priority have been supplied with power.

The first device uᵢ in the ranking established in step S6 is first selected in step S71.

In step S72, the cost of the electrical consumption incurred by supplying electricity to this device uᵢ can be determined for a series of starting times for supplying it with power, assuming the power is supplied continuously in accordance with the values of the power rating Pᵢ for each period it is supplied, limit times τᵢ and τᵢ′, and the supply duration tcᵢ. The starting times to be tested for the device uᵢ are therefore between τᵢ and τᵢ′−tcᵢ, and a constant minimum increment can be used between two successive times which are tested. The calculation of the cost of the electrical consumption incurred by supplying electricity to the device uᵢ based on each hypothesized supply starting time is known to the skilled person, and it is not necessary to detail it here. It is based on the pricing data for the consumption time slots concerned, the power rating value Pᵢ, and the supply duration for each time slot. In step S73, the starting time for which the cost of electrical consumption is the lowest among all the starting times tested is determined. This starting time which produces the lowest cost is denoted t_{d}_{_}ₒₚₜᵢ in FIG. 3.

Then, in step S74, it is verified that the power rating value Pᵢ of the device uᵢ does not exceed the available electric power value Pₐᵥ for all time slots concerned by the supply duration tcᵢ initiated at time t_{d}_{_}ₒₚₜᵢ. In other words, this verification ensures that the total electric power provided to the device uᵢ in addition to the priority devices does not exceed the value of the maximum electric power which is available at the delivery point 1. If no such overload is found, supplying the device uᵢ starting at time t_{d}_{_}ₒₚₜᵢ is approved, and the power rating value Pᵢ is subtracted from the available electric power value Pₐᵥ for the time slots between t_{d}_{_}ₒₚₜᵢ and t_{d}_{_}ₒₚₜᵢ+tcᵢ (step S75).

Optionally, step S76 may consist in updating the cost of the electrical consumption already committed, called the total cost of electrical consumption, by adding the electrical consumption incurred by supplying device uᵢ starting at supply starting time t_{d}_{_}ₒₚₜᵢ, to the consumption costs of the priority devices.

The steps just described, S71 to S77, are then repeated for all devices for which the supply of electricity can be deferred, taken one by one in the ranking order established in step S6, until this ranking list is exhausted (step S77). The values of the available electric power Pₐᵥ and the total cost of electrical consumption which thus result from successive executions of steps S75 and S76 include the electricity supplied to the devices uᵢ for which step S7 has been previously executed.

Step S8 is carried out if the management method of the invention is implemented in real time while the devices of the residence 101 are being supplied with electrical energy in accordance with the management determined by the method. If the devices are not being supplied with electrical energy, or are not being supplied in accordance with the management determined by the method of the invention, the use of this method provides a management plan, with a projected cost of consumption which is optimized.

Step S9 allows taking into account changes in the input data which are taken into account for the method. Such changes may include the following:
pricing data for at least some of the time slots;
a change in the value of the maximum electric power that is available from the delivery point 1;
a change in at least one supply mode characteristic of one of the devices having priority or able to be deferred, among: the electrical consumption of this device, its power rating value, its supply limit times, and its supply duration;
for execution of the method in real time while devices are being supplied with electrical energy: a new starting of a priority device or a stopping of a priority device, possibly sent to input 2d of the module 2; updated values of the power ratings of at least some of the devices, possibly received at input 2c; a warning of exceeding the maximum electric power available at the delivery point 1; a new measurement result which may be sent to the module 2 at input 2e and be used to correct the available electric power value Pₐᵥ, etc.;
an additional device consuming electrical energy which is newly connected to the module 2; and
a dummy device to be added to the ranking of step S6 as will be described further below.

We now describe the continuation of the method, starting from step S74, when the value of the power rating Pᵢ appears greater than that of the available electric power Pₐᵥ for certain time slots between t_{d}_{_}ₒₚₜᵢ and t_{d}_{_}ₒₚₜᵢ+tcᵢ. Such a situation of exceeding the electric power can be treated differently depending on whether the device uᵢ is able to operate in several different supply modes (step S74_1). A device uᵢ with several supply modes is said to be a flexible power supply device in the context of the present invention.

When the device uᵢ has only one supply mode (step S74_1), meaning that there is only one power rating value Pᵢ at each moment during its supply duration tcᵢ, as was the case to this point, in other words the device uᵢ is not flexible power supply device, the starting time t_{d}_{_}ₒₚₜᵢ determined in the previous execution of step S73 is introduced into a list of excluded times which is established for this device uᵢ (step S74_2). Initially, for the execution of step S7 for the device uᵢ, this list is empty. Step S73 is then repeated to conduct a new search for a time to start supplying electricity to the device uᵢ, that is not in the list of excluded times resulting from previous (possibly multiple) executions of step S74_2 for the same device uᵢ. Such devices uᵢ that are not power-flexible, for example, the dishwasher 21 and the washing machine 22, grouped under the reference 20 in FIG. 1.

The improvement of the invention which is now described relates to those devices uᵢ which are flexible power supply devices. Such devices may be, for example, the battery charger connected to the electric vehicle 31, or some models of domestic hot water production devices 32. These flexible power supply devices are grouped under the reference 30 in FIG. 1. Such devices each have multiple supply modes, which are characterized by respective reduction coefficients in the power rating value Pᵢ. These reduction coefficients are denoted ρᵢ for device uᵢ. The power rating value of the supply mode is then considered to be ρᵢ×Pᵢ, the reduction coefficient ρᵢ being a real number between zero and one, specific to the supply mode concerned. In the case where the device uᵢ is a flexible power supply device (step S74_1), the supply starting time t_{d}_{_}ₒₚₜᵢ which was determined in step S73 for device uᵢ is approved, and for each of the time slots where the power rating value Pᵢ is greater than the available electric power value Pₐᵥ, the supply mode of the device uᵢ which has the highest power rating value ρᵢ×Pᵢ while being less than or equal to the available electric power value Pₐᵥ is adopted (step S74_3). For the other time slots, where the power rating value Pᵢ is less than or equal to the available electric power value Pₐᵥ, the supply mode corresponding to the power rating value Pᵢ is retained, meaning the maximum power rating value for the device uᵢ The left branch of the method as shown in FIG. 3 is then resumed in step S75.

Previously, a deficit in the electrical consumption was calculated in step S74_4 for the device uᵢ, resulting from the electrical energy that was not supplied to the device uᵢ during the time slots where a supply mode having a reduced power rating value was adopted. This consumption deficit can be determined in various ways which yield varying levels of accuracy. For example, this deficit can be calculated for the device as the sum, for all durations where a supply mode with reduced power was adopted, of terms of type (1−βᵢ)×Pᵢ×Δt, where Δt is how long the supply mode corresponding to the reduction coefficient ρᵢ was adopted.

This electrical energy deficit can then be handled in the method of the invention in the form of a new dummy device consuming electrical energy (step S74_5): The value of the electrical energy deficit calculated for the device uᵢ is assigned to the dummy device as its electrical consumption value, denoted E_{fictif}, then the dummy device is inserted into the list of devices uᵢ ranked in descending order of their electrical consumption values. Alternatively, the dummy device may be inserted at the top of this ranking, regardless of the electrical consumption value E_{fictif}, so that priority is given to continuing or terminating the supply of electricity to the flexible power supply device uᵢ over the other devices of groups 20 and 30 which have not yet been supplied with power. The number N of devices uᵢ is simultaneously incremented by one for the test of step S77. The added dummy device may have the same values as the device uᵢ for the power rating Pᵢ, for the power rating reduction coefficient ρᵢ corresponding to different supply modes that are repeated for the dummy device, and for the limit times τᵢ and τᵢ′. The supply duration to be assigned to each supply mode of the dummy device can then be calculated from the value E_{fictif} adopted for the electrical consumption of the dummy device, the power rating Pᵢ, and possibly also the reduction coefficient ρᵢ of the supply mode concerned. Without taking into account the reduction coefficient ρᵢ, the supply duration of the dummy device may be assumed to be equal to E_{fictif}/Pᵢ. In addition, the times for which the device uᵢ is or will be supplied with electricity in accordance with the reduction coefficient ρᵢ are introduced into a list of excluded times relating to the dummy device. This list of excluded times will be used in the subsequent execution of step S73 for the dummy device.

It is understood that the invention can be reproduced by adapting or modifying some details of the description just given, while retaining at least some of the cited advantages. In particular, the data required for the method of the invention can be acquired in many ways: by manual input, automatic transmission, machine-learning, etc. In addition, the invention is compatible with any method for estimating the cost of electrical consumption, and any method for estimating the electrical consumption deficit concerning a device for which a supply mode at reduced power has been adopted. Finally, the method can be applied in order to provide device management for periods of any duration.

Moreover, the electrical energy management module 2 may itself control the electric power supplied to the devices of groups 20 and 30, at each power output 2s, according to the device that is connected to that output. This may be the case for the domestic hot water production device 32. Alternatively, an intermediate module may be arranged between a device and the power output 2s which is dedicated to that device. This intermediate module may then regulate the instantaneous electric power that is delivered to the device, in accordance with instructions it receives from the electrical energy management module 2. The transmission of such instructions between the electrical energy management module 2 and the intermediate module may advantageously be wireless. In particular, for recharging the batteries of the electric vehicle 31, such an intermediate module may be included in a vehicle recharging terminal.

1. A method for managing a group of electrical energy consuming devices, in order to supply said devices with electrical energy from an electrical energy delivery point common to said devices, the method comprising the following steps:
/1/ collecting the values of an electric power available at the delivery point as a function of successive time slots, and collecting electrical consumption pricing data for each of said time slots;
/2/ for each device: collecting characteristics of a supply mode of said device, comprising an electrical consumption value, a power rating value and a supply duration, the power rating value being defined for each moment of the supply duration, and further collecting two limit times between which said supply duration is to be scheduled;
/3/ ranking the devices of the group in descending order of their electrical consumption values;
/4/ for the first device in the ranking established in step /3/, performing the following substeps:
/4-1/ determining a starting time for supplying electricity to said first device, which satisfies the following conditions:
allows supplying the first device in accordance with the supply mode characteristics and within the limit times collected for said first device;
the power rating of the first device is less than or equal to the value of the electric power that is available from the delivery point for the entire supply duration of said first device from the starting time; and
the starting time minimizes a cost of supplying electricity to the first device, calculated by applying the pricing data; and
/4-2/ updating the values of the electric power that is available from the delivery point, by subtracting the value of the power rating of said first device for each time slot during the supply duration of the first device from the starting time, and without modifying the values of the electric power that is available from the delivery point outside of the supply duration of the first device; and
/5/ repeating step /4/ for each device of the group, in the order of the ranking established in step /3/, and with the updated values of the electric power that is available from the delivery point.

2. The method according to claim 1, wherein one of the devices of the group comprises an electric vehicle connected to the delivery point in order to charge batteries of said vehicle, or a domestic hot water production system.

3. The method according to claim 1, wherein, in step /1/, the values of the electric power that is available at the delivery point are calculated for each time slot based on a fixed maximum electric power value for the delivery point, from which is subtracted a power rating value relative to at least one other power consuming device, in addition to the group of devices, and which has priority for being supplied with electrical energy from the delivery point.

4. The method according to claim 3, wherein each device having priority for the supply of electricity is indicated to a power manager implementing the management method, or is identified by the power manager via machine-learning based on priority information which has been entered at multiple occasions by a user during a first time period.

5. The method according to claim 1, wherein at least one of the devices of the group of devices, said to be a flexible power supply device, has multiple supply modes associated with respective power rating values which are different,
and wherein steps /3/ and /4/ are executed for the flexible power supply device by adopting that of the supply modes of said flexible power supply device which has the highest power rating value, referred to as the first supply mode, in order to determine the starting time for supplying electricity,
and if time slots exist subsequent to the starting time and during the supply duration of the first supply mode, for which the power rating value of said first supply mode is greater than the value of the electric power that is available at the delivery point, adopting for said subsequent time slots one of the other supply modes of the flexible power supply device, which among said supply modes has the largest of the power rating values that are less than or equal to the available electric power value,
and wherein an electrical consumption deficit is calculated for the flexible power supply device, said consumption deficit resulting from the adoption of a supply mode other than said first supply mode, and a dummy device is added to the group of devices processed according to the management method, which has a plurality of supply modes with the same power rating values as the flexible power supply device, but using the electrical consumption deficit calculated for the flexible power supply device as the electrical consumption value for the supply modes of the dummy device, and for determining the respective supply durations of said supply modes of the dummy device.

6. The method according to claim 5, wherein the flexible power supply device comprises an electric vehicle that is connected to the delivery point in order to charge batteries of said vehicle, or a domestic hot water production system.

7. The method according to claim 1, wherein the characteristics of each supply mode of at least one of the devices are sent to a power manager implementing the management method, by an operator of the device or by said device, or are determined by said power manager via machine-learning based on power characteristics recorded during a second period of time.

8. The method according to claim 1, wherein the electrical energy delivery point is assigned to a residence, in particular an apartment or a house, at least a part of a building, in particular a multi-dwelling residential building or a commercial building, or at least part of a site, in particular an industrial site.

9. The method according to claim 1, wherein the devices of the group are supplied with electrical energy from the delivery point in accordance with starting times determined during executions of substep /4-1/ and with the supply modes of the devices used to determine said starting times, or adopted for each time slot.

10. The method according to claim 9, wherein at least some of the supply mode characteristics, among the electrical consumption value, the power rating value, and the supply duration, are updated for at least one of the devices while said device is being supplied with electrical energy in accordance with the management method, based on at least one power measurement which is performed in real time for said device.

11. The method according to claim 1, wherein step /4/ further comprises the following substep:
/4-3/ updating a value for the total cost of electrical consumption, by adding the cost of the electrical consumption of the device for which the starting time for supplying electricity was determined in the last execution of substep /4-1/, to a previous value of the total cost of electrical consumption determined based on the devices for which the starting times for supplying electricity were determined in previous executions of substep /4-1/.

12. An electrical energy management module, comprising:
a first input adapted to receive values of a maximum electric power which is available at an electrical energy delivery point shared between multiple devices which consume electrical energy;
a second input adapted to receive electrical consumption pricing data for successive electrical consumption time slots;
third inputs adapted to receive characteristics of respective supply modes of the devices; and
power outputs adapted to be each connected to at least one of the devices, in order to supply said devices with electrical energy,
said module being adapted to implement the management method according to claim 1.

13. The electrical energy management module according to claim 12, further comprising a fourth input adapted to receive at least one information item designating one of the devices as having priority for the supply of electrical energy,
and the module is further adapted to subtract the power rating value of each priority device designated by such an information item, from the value of the maximum electric power that is available at the delivery point, so as to obtain a value for the electric power that is available for supplying the at least one device not designated as having priority for the supply of electrical energy.

14. The electrical energy management module according to claim 12, further comprising first storage means adapted to store priority information which has been entered at multiple occasions by a user during a first period of time, and further comprising first learning means adapted to automatically identify at least one of the devices as having priority for the supply of electrical energy, based on said entered priority information,
and the module is further adapted to subtract the power rating value of each priority device identified by learning, from the value of the maximum electric power that is available at the delivery point, so as to obtain a value for the electric power that is available to supply the at least one of the devices not designated as having priority for the supply of electrical energy.

15. The electrical energy management module according to claim 12, further comprising second measurement and storage means adapted for measuring and storing the power characteristics of the devices during a second period of time, and further comprising second learning means adapted for automatically determining the characteristics of each supply mode of at least one of the devices, based on the power characteristics recorded.

16. The electrical energy management module according to claim 12, adapted for being installed at the electrical energy delivery point of a residence, in particular an apartment or a detached house, at least part of a building, in particular a multi-dwelling residential building or a commercial building, or at least part of a site, in particular an industrial site.
